(19) United States
(12) Patent Application Publication
(10) Pub. No.: US 2007/0234330 A1
(43) Pub. Date: Oct. 4, 2007

(54) Prevention of executable code modification

(75) Inventor: Scott A. Field, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/365,364

(22) Filed: Mar. 1, 2006

(51) Int. Cl. G06F 9/44

(52) U.S. Cl. 717/165

(57) ABSTRACT

Prevention of executable code modification is provided by making the act of allocating and modifying existing memory backed code pages a highly privileged operating system (OS) function. The integrity of loaded code is also optionally checked at load time inside the OS kernel. A privilege check in the system is invoked when executable pages are allocated or modified. This privilege is assigned only to the operating system kernel and highly trusted identities in the operating system.

### COPYRIGHT NOTICE AND PERMISSION

A portion of the disclosure of this patent document may contain material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice shall apply to this document: Copyright® 2006, Microsoft Corp.

### BACKGROUND

Today, malicious software code (i.e., malware) causes damage to a computing system by gaining control of the CPU processor and then executing malicious CPU instructions (code). Today's approaches to dealing with malware are not entirely effective. One common approach to dealing with viruses is to use a signature-based virus detection tool. Unfortunately, this approach will not detect the next variation of the same attack. Because these viruses spread so quickly, the reactive approach to virus detection is not effective in stopping many types of viruses. Thus, prevention of execution of malicious code is becoming increasingly important as new and more invasive code is becoming more prevalent.

Also, current operating systems allow non-privileged user code free reign to allocate and modify executable pages. Hence, if an attacker is able to penetrate an existing program (eg: through buffer overflow or other programming errata), they are free to modify the penetrated program in memory, or cause new CPU instructions to be executed from disk or other media.

Thus, needed are processes and a system that addresses the shortcomings of the prior art.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In consideration of the above-identified shortcomings of the art, prevention of executable code modification and prevention of unauthorized code loading is provided. For several embodiments, a method for prevention of executable code modification comprises restricting a function of loading executable code into memory to a privileged ring of a computer's operating system (OS). Also, the method may further comprise enforcing page-level protection of the executable code. A privilege check may also be invoked when an executable page of the executable code is allocated or when an attribute of the executable page is changed. The privilege check determines, for example, whether a privilege that is only assigned to the privileged ring of the OS is present before allowing the allocation of the executable page or change of the attribute of the executable page. In addition to or in the alternative to the above, checking integrity of the executable code before or after it is loaded into memory is performed.

Alternatively a method for prevention of modification of data pages, as opposed to just executable code, is employed comprising restricting a function of loading data pages into memory to a privileged ring of a computer's operating system.

Other advantages and features of the invention are described below.

### BRIEF DESCRIPTION OF THE DRAWINGS

Prevention of executable code modification is further described with reference to the accompanying drawings in which:

FIG. 1 is a block diagram representing an exemplary computing device suitable for use in conjunction with prevention of executable code modification;

FIG. 2 illustrates an exemplary networked computing environment in which many computerized processes may be implemented to perform prevention of executable code modification;

FIG. 3 is a diagram illustrating a process of prevention of executable code modification using privilege checks;

FIG. 4 is a block diagram illustrating an example architecture of an operating system's user mode and kernel mode features;

FIG. 5 is a diagram illustrating a process of prevention of executable code modification using security checks in kernel mode execution; and

FIG. 6 is a diagram illustrating example security checks used in the process of prevention of executable code modification shown in FIG. 5.

### DETAILED DESCRIPTION

Certain specific details are set forth in the following description and figures to provide a thorough understanding of various embodiments of the invention. Certain well-known details often associated with computing and software technology are not set forth in the following disclosure to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

Example Computing Environments

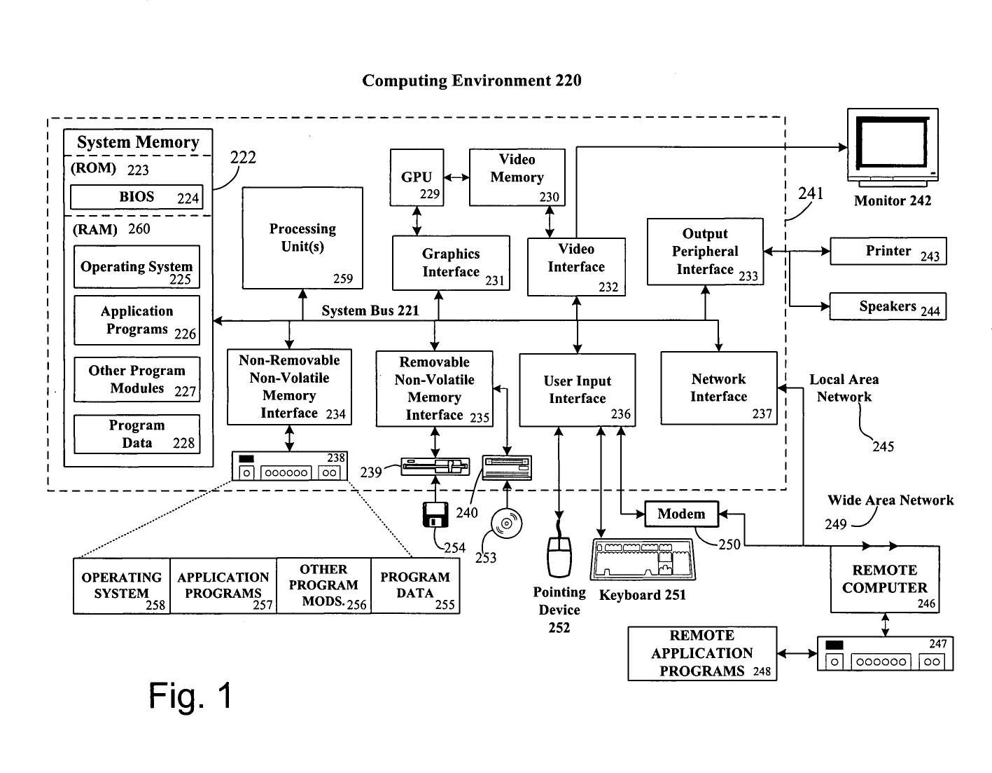

Referring to FIG. 1, shown is a block diagram representing an exemplary computing device suitable for use in conjunction with implementing the processes described above. For example, the computer executable instructions that carry out the processes and methods for prevention of executable code modification may reside and/or be executed in such a computing environment as shown in FIG. 1. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220. For example a computer game console may also include those items such as those described below for use in conjunction with implementing the processes described above.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, interpreted code, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 1 illustrates operating system 225, application programs 226, other program modules 227, and program data 228.

The computer 241 may also include other removable/non-removable, volatile/nonvolatile computer storage media. By way of example only, FIG. 1 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 1, provide storage of computer readable instructions, data structures, program modules and other data for the computer 241. In FIG. 1, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 1. The logical connections depicted in FIG. 1 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 1 illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

In light of the diverse computing environments that may be built according to the general framework provided in FIG. 1, the systems and methods provided herein cannot be construed as limited in any way to a particular computing architecture. Instead, the invention should not be limited to any single embodiment, but rather should be construed in breadth and scope in accordance with the appended claims.

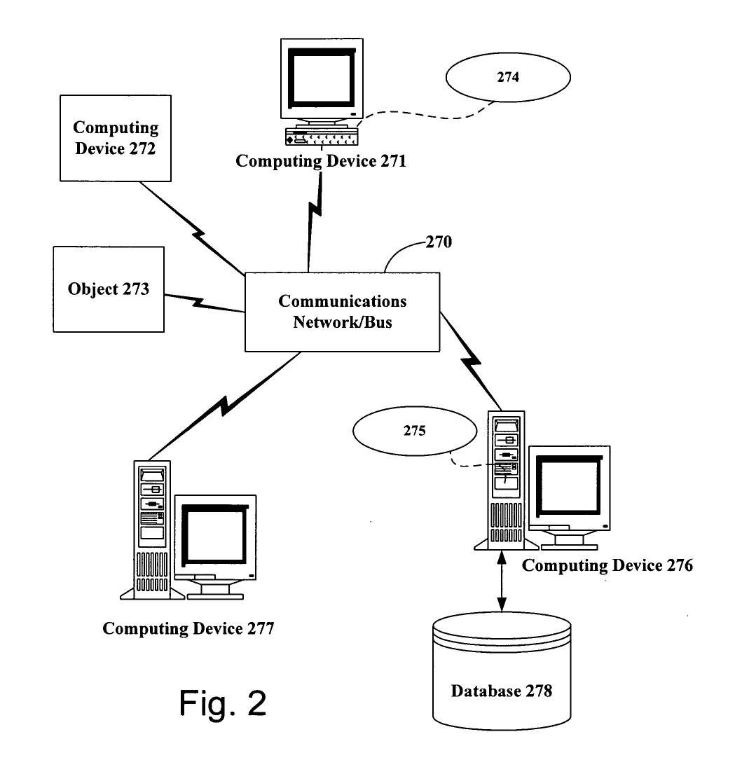

Referring next to FIG. 2, shown is an exemplary networked computing environment in which many computerized processes may be implemented to perform the processes described above. For example, parallel computing may be part of such a networked environment with various clients on the network of FIG. 2 using and/or implementing prevention of executable code modification. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

FIG. 2 provides a schematic diagram of an exemplary networked or distributed computing environment. The environment comprises computing devices 271, 272, 276, and 277 as well as objects 273, 274, and 275, and database 278. Each of these entities 271, 272, 273, 274, 275, 276, 277 and 278 may comprise or make use of programs, methods, data stores, programmable logic, etc. The entities 271, 272, 273, 274, 275, 276, 277 and 278 may span portions of the same or different devices such as PDAs, audio/video devices, MP3 players, personal computers, etc. Each entity 271, 272, 273, 274, 275, 276, 277 and 278 can communicate with another entity 271, 272, 273, 274, 275, 276, 277 and 278 by way of the communications network 270. In this regard, any entity may be responsible for the maintenance and updating of a database 278 or other storage element.

This network 270 may itself comprise other computing entities that provide services to the system of FIG. 2, and may itself represent multiple interconnected networks. In accordance with an aspect of the invention, each entity 271, 272, 273, 274, 275, 276, 277 and 278 may contain discrete functional program modules that might make use of an API, or other object, software, firmware and/or hardware, to request services of one or more of the other entities 271, 272, 273, 274, 275, 276, 277 and 278.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 2, any entity 271, 272, 273, 274, 275, 276, 277 and 278 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

In light of the diverse computing environments that may be built according to the general framework provided in FIG. 2 and the further diversification that can occur in computing in a network environment such as that of FIG. 2, the systems and methods provided herein cannot be construed as limited in any way to a particular computing architecture. Instead, the invention should not be limited to any single embodiment, but rather should be construed in breadth and scope in accordance with the appended claims.

Hardware and Operating System Prevention of Executable Code Modification

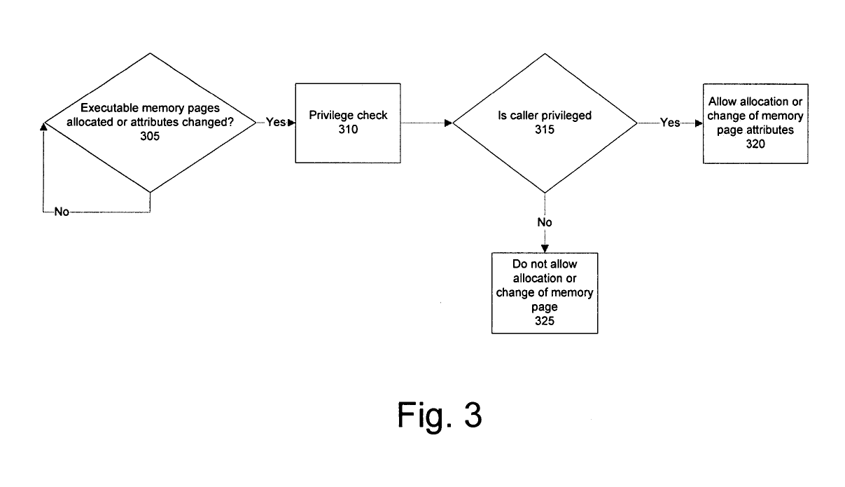

Referring next to FIG. 3, shown is a diagram illustrating a process of prevention of executable code modification using privilege checks. Support is added to the operating system (OS) memory manager to check whether the caller is privileged when allocating or changing the attributes of executable memory pages. Modern x64 and AMD® CPUs allow hardware based enforcement and tracking of executable pages. For example, Beginning with Windows XP® Service Pack 2, the 32-bit version of Windows® utilizes the no-execute page-protection (NX) processor feature as defined by AMD® or the Execute Disable bit feature as defined by Intel®. In order to use these processor features, the processor must be running in Physical Address Extension (PAE) mode. The 64-bit versions of Windows XP® uses the NX processor feature on 64-bit extensions and certain values of the access rights page table entry (PTE) field on IPF processors.

Execute Disable Bit capability is an enhancement to 32-bit Intel® architecture. An IA-32 processor with Execute Disable Bit capability can protect data pages against being used by malicious software to execute code. The processor provides page protection in either of the following modes:
Legacy protected mode, if Physical Address Extension (PAE) is enabled.
IA-32e mode, when Intel® Extended Memory 64 Technology (Intel® EM64T) is enabled.

Note that entering IA-32e mode requires enabling PAE. While the Execute Disable Bit capability does not introduce new instructions, it does require operating systems to operate in a PAE enabled environment and to establish a page-granular protection policy for memory.

Software can detect the presence of the Execute Disable Bit capability using the CPUID instruction with the input value 80000001H in EAX. Presence is indicated by a value returned in EDX. If bit 20 of EDX is set, the Execute Disable Bit is available. If CPUID extended function 80000001H reports that Execute Disable Bit capability is available and PAE is enabled, software can enable the Execute Disable Bit capability by setting the NXE bit to 1 in IA32_EFER MSR (address C0000080H). IA32_EFER is available if bit 20 or bit 29 of the EDX register returned by CPUID-extended function 80000001H is 1.

When Physical Address Extension is enabled (either in IA-32e mode or in legacy protected mode), Execute Disable Bit capability is enabled by setting bit 11 of IA32_EFER to 1. If CPUID extended function 80000001H reports Execute Disable Bit capability is not available, bit 11 of IA32_EFER is reserved. A write to IA32_EFER.NXE will produce a #GP exception. The Microsoft Windows® memory manager also tracks page attributes on allocated memory pages.

Referring again to FIG. 3, if executable memory pages are allocated or their attributes changed 305, then a privilege check is performed 310 to determine 315 if the caller has the correct privileges to do the memory page allocation or attribute change. If the correct privileges are present, then the allocation or change of attribute of the memory page is allowed by the OS. If not, then the allocation or change of attribute of the memory page is not allowed by the OS 325.

Before code can be run, all of the object code needs to be converted into executable code. The object code is collected together and information is added about how each routine can reference the other routines and system functions it needs to call. In many software environments, all of the object code is linked together into a single “Executable Image,” a large piece of machine language code containing all of the routines and stored on disk. At run time, this one large executable image is loaded into main memory and then executed. In another aspect of prevention of executable code modification, functions such as loading an executable image are moved from user mode into kernel mode.

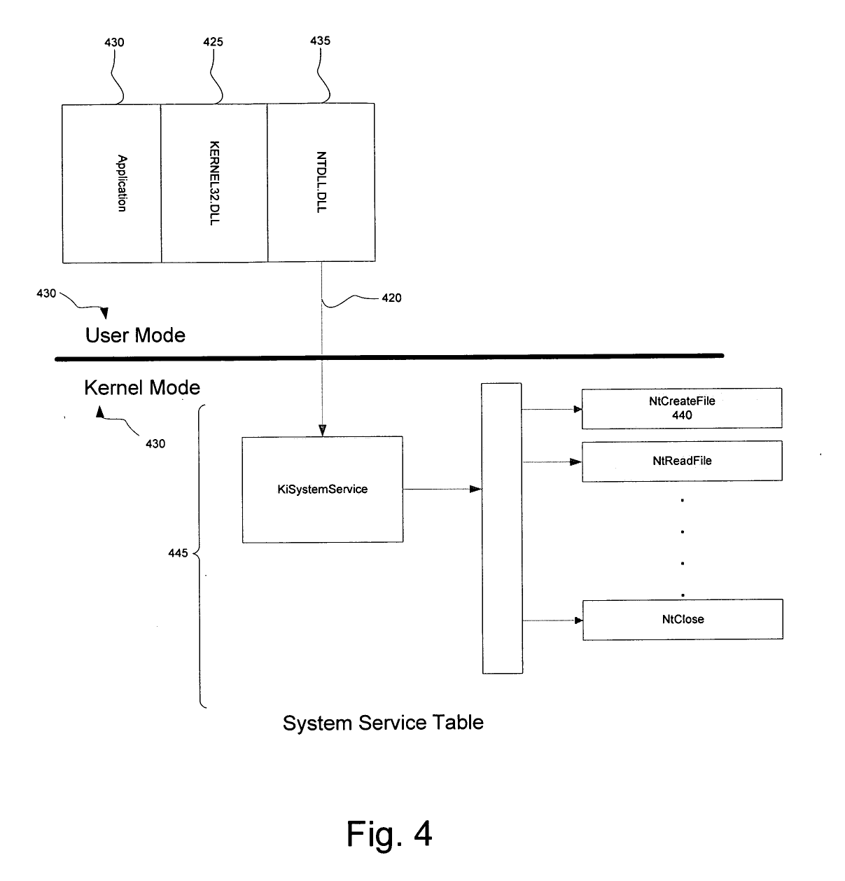

Referring next to FIG. 4, shown is a block diagram illustrating an example architecture of an operating system's user mode and kernel mode features. For example, kernel mode 405 is where the core of Microsoft NT® executes, and it is in kernel mode 405 that components have direct access to hardware and services that perform management of the computer's resources including memory, devices and processes. Thus, whenever a program executing in user mode 410 wants to perform I/O, allocate or deallocate virtual memory, start a thread or process, or interact with global resources, it must call upon 420 one or more services 445 that live in kernel mode 405.

KERNEL32 425 functions that call the native application programming interface (API) directly include all of its I/O (e.g CreateFile( ), ReadFile( ), WriteFile( )), synchronization (e.g. WaitForSingleObject( ), SetEvent( )), and memory management (e.g VirtualAlloc( ), VirtualProtect( )) functions. In fact, the majority of KERNEL32's 425 exported routines use the Native API directly. FIG. 4 shows the flow of control from a Win32 application 430 executing a Win32 call (CreateFileo), through KERNEL32 425, NTDLL 435, and into kernel mode 405 where control is transferred to the NtCreateFile 440 system service.

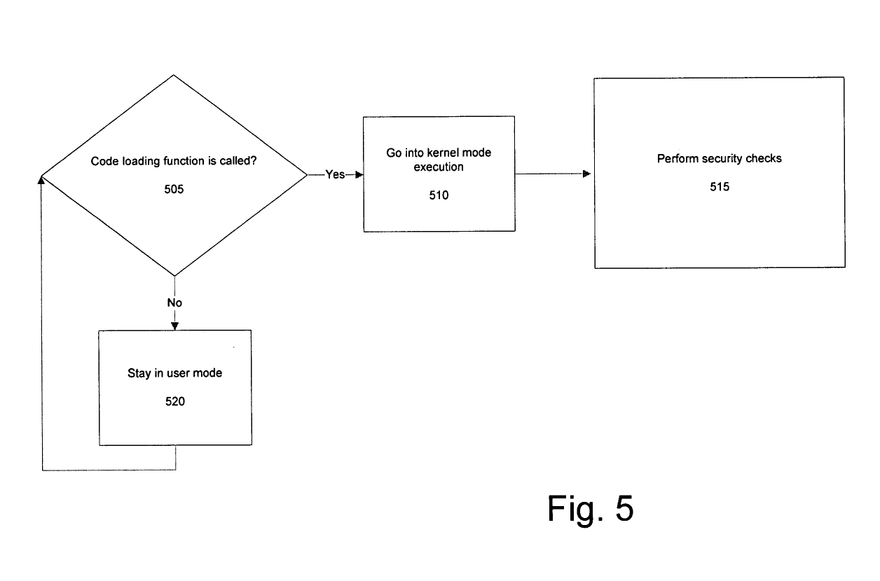

Referring next to FIG. 5, shown is a diagram illustrating a process of prevention of executable code modification using security checks in kernel mode execution. In moving functions such as loading an executable image from user mode into kernel mode 405, if a function is called that loads an executable code image 505, then a switch is made 510 into kernel mode 405, such that proper security checks can be made 515. Otherwise execution of the application stays in user mode 410. Ordinary user mode code would not have sufficient privilege to allocate executable code pages. Most code is not self-modifying, so this could be enforced fairly broadly across a Microsoft Windows® based system, for example.

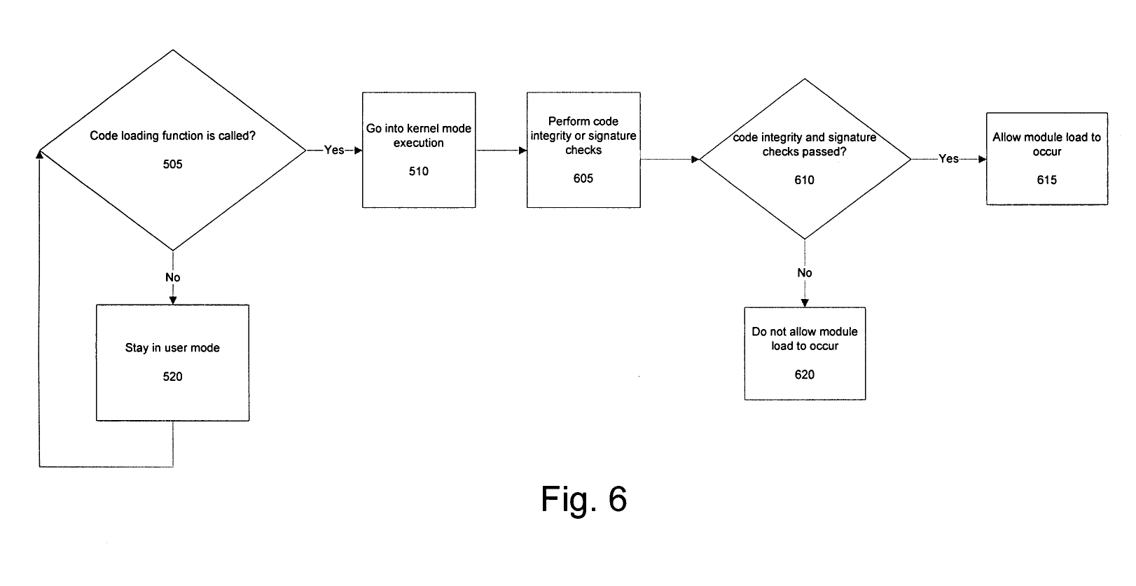

Referring next to FIG. 6, shown is a diagram illustrating example security checks used in the process of prevention of executable code modification shown in FIG. 5. If an application triggers loading of an executable code image 505, then a switch by the OS is made 510 into kernel mode 405, such that proper security checks can be made such as code integrity, signature checks, or other security policy checks 605 inside the kernel. For example a code integrity check may be cryptographic checksum that is a mathematical value (called a checksum) that is assigned to a file and used to “test” the file at a later date to verify that the data contained in the file has not been maliciously changed. A cryptographic checksum is created by performing a complicated series of mathematical operations (known as a cyrptographic algorithm) that translates the data in the file into a fixed string of digits called a hash value, which is then used as a checksum. Without knowing which cryptographic algorithm was used to create the hash value, it is highly unlikely that an unauthorized person would be able to change data without inadvertently changing the corresponding checksum. Cryptographic checksums are also known as message authentication codes, integrity check-values, modification detection codes, or message integrity codes.

The signature is an encrypted mathematical summary of the data in the object. Therefore, the signature is considered to match and be valid if the data in the object during verification matches the data in the object when it was signed. An invalid signature is determined based on a comparison of the encrypted mathematical summary that is created when the object is signed and the encrypted mathematical summary done during signature verification. The signature verification process compares the two summary values. If the values are not the same, the contents of object have changed since it was signed and the signature is considered to be invalid. Referring again to FIG. 6, if the code integrity or signature checks pass 610, then the module load is allowed to occur 615. Otherwise, the module load is not allowed to occur 620. It is also important to note that the processes describe herein need not be specific to executable pages, it could also be extended to read-only data pages, and any other aspects of the loaded module, for example.

An example of an additional security policy check may involve limiting the type of module, or the origin of the module being loaded. For example, a Microsoft Windows System service may be configured to only allow Microsoft executable code, in native format, to be loaded.

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, such as that shown in the figure below, a video recorder or the like, the machine becomes an apparatus for practicing the invention. When implemented on a general-purpose processor, the program code combines with the processor to provide a unique apparatus that operates to perform the indexing functionality of the present invention.

While the present invention has been described in connection with the preferred embodiments of the various figures, it is to be understood that other similar embodiments may be used or modifications and additions may be made to the described embodiment for performing the same function of the present invention without deviating there from. Furthermore, it should be emphasized that a variety of computer platforms, including handheld device operating systems and other application specific hardware/software interface systems, are herein contemplated, especially as the number of wireless networked devices continues to proliferate. Therefore, the present invention should not be limited to any single embodiment, but rather construed in breadth and scope in accordance with the appended claims.

Finally, the disclosed embodiments described herein may be adapted for use in other processor architectures, computer-based systems, or system virtualizations, and such embodiments are expressly anticipated by the disclosures made herein and, thus, the present invention should not be limited to specific embodiments described herein but instead construed most broadly.

What is claimed:

1. A method for prevention of executable code modification comprising:
restricting a function of loading executable code into memory to a privileged ring of a computer's operating system (OS).

2. The method of claim 1 further comprising enforcing page-level protection of the executable code.

3. The method of claim 2 further comprising invoking a privilege check when an executable page of the executable code is allocated or when an attribute of the executable page is changed.

4. The method of claim 3 wherein the privilege check determines whether a privilege that is only assigned to the privileged ring of the OS is present before allowing the allocation of the executable page or change of the attribute of the executable page.

5. The method of claim 4 further comprising checking integrity of the executable code after it is loaded.

6. The method of claim 5 wherein the page level protection is performed using hardware-based enforcement and tracking of executable pages.

7. A computer readable medium having instructions thereon for performing the step of claim 1.

8. A computer readable medium having instructions thereon for performing the steps of claim 2.

9. A computer readable medium having instructions thereon for performing the steps of claim 3.

10. A computer readable medium having instructions thereon for performing the steps of claim 4.

11. A computer readable medium having instructions thereon for performing the steps of claim 5.

12. A computer readable medium having instructions thereon for performing the steps of claim 6.

13. A system for prevention of executable code modification comprising:
means for restricting a function of loading executable code into memory to a privileged ring of a computer's operating system (OS).

14. The system of claim 13 further comprising means for enforcing page-level protection of the executable code.

15. The system of claim 14 further comprising means for invoking a privilege check when an executable page of the executable code is allocated or when an attribute of the executable page is changed.

16. The system of claim 15 wherein the means for invoking the privilege check determines whether a privilege that is only assigned to the privileged ring of the OS is present before allowing the allocation of the executable page or change of the attribute of the executable page.

17. The system of claim 16 further comprising means for checking integrity of the executable code after it is loaded.

18. The system of claim 17 wherein the means for enforcing page level protection comprises means for hardware-based enforcement and tracking of executable pages.

19. A method for prevention of modification of data pages comprising:
restricting a function of loading data pages into memory to a privileged ring of a computer's operating system (OS).

20. A computer readable medium having instructions thereon for performing the step of claim 19.
